(19) United States
(12) Patent Application Publication
(10) Pub. No.: US 2007/0171376 A1
(43) Pub. Date: Jul. 26, 2007

(54) PROJECTION DISPLAY SYSTEM

(75) Inventors: Dongxue Wang, Palatine, IL (US); Zili Li, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,751

(22) Filed: Jan. 26, 2006

(51) Int. Cl. G03B 21/26

(52) U.S. Cl. 353/30

(57) ABSTRACT

A projector system comprises an illumination system, at least one imager, a diffuser, and a projection lens. The illumination system generates a collimated light, which is provided to the imager. The at least one imager modulates the collimated light according to the information required for image formation. The diffuser receives the modulated collimated light, and diffuses it into a divergent light, thereby relaying the image from the imager to the diffuser. The projection lens projects the divergent light on the projection screen.

### FIELD OF THE INVENTION

The present invention relates to projection display systems or projector systems and specifically to compact projector systems with increased projection efficiency.

### BACKGROUND

A projector system is an image display system that is used to enlarge and project images on a projection screen. Projector systems are used in home theatres, projection TVs, large panel business displays, and so forth.

A projector system has two main components, namely, an illumination system and an imaging system. The illumination system has a light source and other optical components that alter the spatial distribution of the light emitted by the light source. The imaging system has optical components such as imagers, a Polarization Beam Splitter (PBS), Total Internal Reflection (TIR) prisms, color-mixing components and projection lenses.

The imagers modulate the light emitted by the illumination system. The modulation by the imagers incorporates the image information required for creating an image in the light. The major technologies used in imagers are of two kinds, reflective technology and transmissive technology. Reflective technologies incorporate modulation information by reflecting the light off the imager. Examples of reflective technologies are Digital Micromirror Device (DMD) and Liquid-Crystal-On-Silicon (LCOS). Transmissive technologies incorporate modulation information by transmitting the light through a imager. An example of transmissive technology is transmissive type Liquid Crystal Display (LCD).

The modulated light, reflected by the imager in the case of reflective design, is passed through a number of intermediate components such as PBS or TIR prisms within the imaging system. These intermediate components operate on the modulated light to perform functions such as changing the direction of the light, initiating/analyzing the polarization effect. After the modulated light has passed through the intermediate components, it is made incident upon the projection lens. The projection lens projects the image displayed on the imager, to form an enlarged image on a target plane, often referred to as a projection screen. Existing reflective type projector systems, based on the technologies mentioned above, face one or more of the inherent shortcomings mentioned hereinafter.

Low projection efficiency is a common shortcoming of reflective type projector systems. The overall projection efficiency of a projector system refers to the ratio of optical power present in the projected image to the optical power present in the light source. Low projection efficiency can be caused by several factors, such as the poor optical efficiency of the optical components in the projector system, and mismatch between the projection lens and lighting distribution at the imager. Low projection efficiency results in low brightness of the enlarged image. The poor optical efficiency of optical components is caused by the use of non-collimated light in projector systems. Non-collimated light does not have a high concentration of optical energy and spreads to varying degrees while traveling through space, especially through intermediate optical components such as PBS or TIR prisms and color mixers. To accommodate for the propagation of non-collimated light, the design of the optical components needs extra engineering to partially improve the performance of the optical components for non-collimated light. Non-collimated light not only lowers the efficiency of the optical components, but it also results in strong multiple reflections from the multiple surfaces of optical components. Consequently, the multiple reflections decrease the transmission efficiency of optical components, and degrade the contrast of the final projected image.

Another shortcoming of existing projector systems is their large size. Due to the use of non-collimated light propagation, optical components, such as PBS, prisms and color mixers are configured to have large size. Moreover, due to the large physical dimensions of the optical components placed between the imager and the projection lens, the projection lens requires a relatively large back focal length. This large back focal length, in turn, increases the size of the projector system, degrades the image quality, and reduces the projection efficiency.

### SUMMARY

The present invention discloses a system and method for the projection/enlargement of an image using a projector system based on the reflective type imager.

In an embodiment of the invention, the projector system comprises an illumination system, at least one imager, a diffuser and a projection lens. The illumination system generates collimated light, which is provided to the imager. The imager modulates the collimated light according to the information required for image formation. The diffuser receives the modulated collimated light, and diffuses it into a divergent light, thereby relaying the image from the imager to the diffuser. Finally, the projection lens projects the optically relayed image at the diffuser on the projection screen. The collimated illumination and the imager relay capability increase the projection efficiency and reduce the overall size of the projector system.

### BRIEF DESCRIPTION OF THE DRAWINGS

Various embodiments of the invention will hereinafter be described in conjunction with the appended drawings provided to illustrate and not to limit the invention, wherein like designations denote like elements, and in which:

FIG. 1 is a block diagram of the projector system that projects an image on a projection screen, in accordance with an embodiment of the present invention;

FIG. 2 illustrates a projector system using LCD technology in the imager, in accordance with an embodiment of the present invention; and

FIG. 3 illustrates a projector system using DMD technology in the imager, in accordance with an embodiment of the present invention.

### DETAILED DESCRIPTION OF EMBODIMENTS OF THE INVENTION

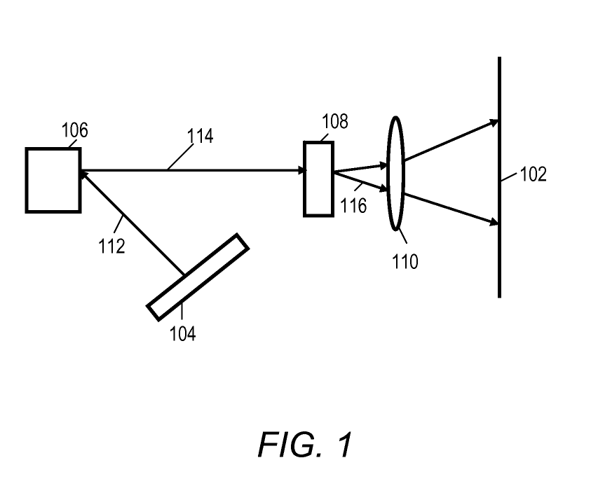

The present invention discloses a projector system that is small in size and has a high projection efficiency. FIG. 1 is a block diagram of the projector system that projects an image on a projection screen, in accordance with an embodiment of the present invention. The projector system projects an image on a projection screen 102, which can be a regular white surface, such as a white paper or a wall. The projector system comprises an illumination system 104, at least one imager 106, a diffuser 108, and a projection lens 110. Illumination system 104 generates a collimated light beam 112, which is provided to imager 106. Imager 106 modulates collimated light 112 according to information required for image formation to generate a modulated collimated light 114 for each pixel. Diffuser 108 receives modulated collimated light 114, and diffuses it into divergent light 116, thereby relaying the image from imager 106 to diffuser 108. Finally, projection lens 110 projects the relayed image with divergent light 116 on projection screen 102.

According to an exemplary embodiment of the present invention, illumination system 104 includes a light source for emitting collimated light. The light source may be one of the group comprising tungsten-halogen lamps, Xenon lamps, ultra high-pressure lamp, high intensity discharge lamps, light emitting diode and laser. In another embodiment of the present invention, illumination system 104 includes a standard light source for emitting non-collimated light, a collimator for collimating the non-collimated light emitted by the standard light source, and Imager 106 can be a monochrome or color imager. In the case of a monochrome imager, three images and a color mixer are usually deployed to combine red, green and blue colors. Alternatively, a color sequential scheme can be used to achieve full-color image.

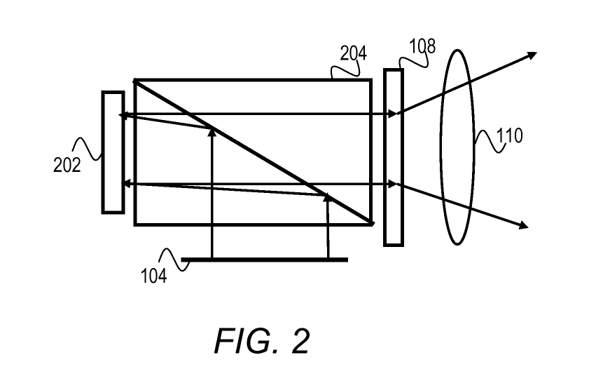

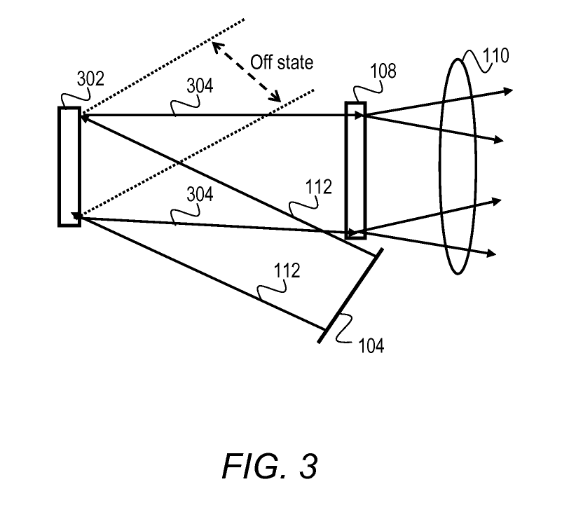

Imager 106 can be implemented by using DMD technology, or an LCD technology such as transmissive LCD or reflective LCOS, in accordance with various embodiments of the present invention. A projector system, implemented in accordance with the LCD or DMD technologies, is explained later in conjunction with FIGS. 2 and 3.

Collimated light 112 has coaxial and parallel paths through space. Collimated light 112 maintains a high degree of collimation while passing through intermediate optical components that are usually placed between imager 106 and diffuser 108. A collimated laser beam may be used for a high-contrast and high-resolution projection displays, such as a Super Video Graphics Array (SVGA) projection or a projection having higher resolution such as XGA resolution. Other sources may be used, of which a number are described above, with a choice of light source depending upon many factors, such as cost, power requirements, display size, and display resolution.

Collimated light 112 can be obtained by collimating the light from lasers, using a beam expander and a collimator. It can also be obtained by collimating the light from an Arc lamp or LEDs, using special designed reflectors such as a parabolic reflector, and a collimation lens. For coherent light, such as a laser beam, and for non-coherent light such as light obtained from resonant cavity LEDs, a highly collimated beam with a divergence angle of several milli-radian is routinely achievable. For non-coherent light such as Arc lamps, the light can be tightly collimated within a range of three degrees, and typically, within 1 degree. Thus, “tightly collimated” as used herein means collimated to within 3 degrees, and “highly collimated” means collimated within the smaller degree range of 0.5 degree. For compact projection system to be used in handheld device, we need to design the collimation as tight as possible to maintain the high quality of image and achieve the full benefit of this invention.

The present invention enables the position of imager 106 to be optically relayed to diffuser 108. In other words, the image seen by projection lens 110 is the image displayed on diffuser 108, which is a duplication of the imaging information at the imager 106. This arrangement also eliminates the need for projection lens 110 to have a large back focal length. In this manner, diffuser 108 facilitates the reduction in the size of the projector system. The reduction in size can be visualized as: (1) transverse size reduction because the beam size for a non-collimated beam increases as light travels farther; and (2) longitudinal size reduction due to the short back focal length of projection lens 110.

Diffuser 108 also provides one more degree of freedom to engineer the cone angle of light distribution to match the f-number of projection lens 110. The f-number is the ratio of the effective focal length to the clear aperture of the projection lens. Generally speaking, the lower the f-number, the greater the projection efficiency and the resolution of the projected image. On the other hand, modulated collimated light 114 maintains the minimum of the Etendue, which is a geometric parameter of an optical beam related to the beam divergence and the cross-sectional area of the light beam. Modulated collimated light 114 reserves its minimum Etendue until it reaches diffuser 108. This minimum Etendue improves the illumination and projection efficiency.

The extent to which diffuser 108 can diverge collimated light 114 depends on its design. The diffusion effect can be achieved by one of a variety of conventional diffusing techniques, such as scattering the light from a rough surface, which happens with a ground glass diffuser, or by microlens effects acheived using tiny microlen arrays, or hologram effects from a holographic diffuser, or by diffusion effects of a plastic film diffuser. These techniques are well known to one skilled in the art. Of course, as they are developed, new techniques could be alternatively be used. The placement of diffuser 108 between imager 106 and projection lens 110 is adjusted to change the cone angle of divergent light 116, received at projection lens 110. This adjustment simplifies the optical design for projection lens 110. In some embodiments, a receiving cone of the projection lens is matched to the divergent cone of the diffuser.

FIG. 2 illustrates a projector system, using LCD technology in the imager, in accordance with embodiments of the present invention. The projector system comprises illumination system 104, an LCD imager 202, a Polarization Beam Splitter (PBS) 204, diffuser 108, and projection lens 110. PBS 204 is a common component for LCD based projector systems. It serves a dual purpose: 1) separating the illumination lighting path from the projection imaging path; and 2) acting as a polarizer and an analyzer for the LCD reflection panel present in LCD imager 202 (since any LCD needs polarized light). In the case of a slanted incidence using non-collimated light, the polarization vectors' directions are incidence-angle dependent, which decreases the contrast of the projected image. To partially overcome this problem, some existing LCD projector systems position a ¼ wave-plate in front of LCD imager 202. However, this problem is eliminated in the projector system provided by the present invention, since the incident-angle dependence of light polarization is naturally eliminated by using a highly collimated incoming light.

FIG. 3 illustrates a projector system using DMD technology in the imager, in accordance with an embodiment of the present invention. The projector system comprises illumination system 104, a DMD imager 302, diffuser 108, and projection lens 110. DMD imager 302 has an array of micro-mirrors, wherein each micro-mirror corresponds to a single pixel of the image. A micro-mirror is adjusted at two distinct angles to modulate collimated light 112 by reflecting collimated light 112 and turning the pixel on and off at high frequency. The pulse width of the modulated light controls the intensity of an image pixel. The DMD based projector system may also include twin prisms (not shown) that are used to fold the optical path, making the overall projection system more compact.

Using collimated light in DMD based projectors also helps in distinctly differentiating between the ‘on’ and ‘off’ states of a particular pixel. To achieve the ‘on’ state and the ‘off’ state of a pixel, a micro-mirror corresponding to the pixel is adjusted at different angles. Therefore, when light is made incident on the micro-mirror in the two states, it is reflected at two different angles. Hence, by using collimated light, a well-defined ‘off’ state of the pixel (that has the minimum possible intensity in the image) is obtained.

The projector system in accordance with embodiments of the present invention described herein can be used for the projection of the gray scale and color images. Color effects, in both DMD and LCOS cases, are achieved by using the following methods

(1) a single imager with color sequential light technology, or

(2) a single color imager. For example, a reflective LCD with color filters;

(3) three imagers corresponding to three different primary colors such as RGB (Red, Green and Blue), and a color mixer/combiner to mix the three RGB collimated light beams.

In the case of a single imager panel with the color sequential technique, three RGB collimated lights are first mixed using a color mixer, and are then launched to the imager. Thereupon, the RGB light is sequentially controlled and synchronized by RGB video information. In an embodiment of the present invention, each individual RGB frame is required to be operated at the speed of at least 75 frames per second to match the response of the human vision. The color sequential technology can be implemented by using solid state lighting, such as the three RGB lasers or an LED. In such a case, RGB light sources are synchronized with RGB video information, and turned on sequentially.

In the case of using three imagers, diffuser 108 is placed after the color mixer to achieve the optical relay of the imager position. The color-mixer device can be implemented by dichroic filter/bandpass filters with multilayer coating.

There are various advantages associated with the present invention. An advantage of the invention is the smaller size of projector system. A smaller size ensures greater portability and lower cost of the projector system. Therefore, in addition to regular projection display, such as TV, home theater and large panel business displays, such projector systems can also be easily used in display systems of mobile devices such as mobile telephones and Personal Digital Assistants (PDAs).

Another advantage of the invention is the improved projection efficiency of the projector system. The use of collimated light improves the brightness of the projected image, without increasing the power consumption of the illumination system.

The use of collimated light in the projector system also helps in reducing the design complexity of the intermediate optical components, as compared to the existing projector systems where non-collimated light is used. The design complexity is reduced because the optical components used in the projector system are optimized for normal incidence, which is achieved by using collimated light. For example, in existing projection systems, where non-collimated light is used, a multi-layer thin film coating is required on the optical components, to optimize their performance for a certain range of incident angles.

In the case of projector systems that employ the DMD technology in their imagers, the use of collimated light helps in achieving the advantage of a distinct differentiation between the ‘on’ and ‘off’ states of an image pixel. This will translate into higher contrast ratio of the resulting image on the screen than the conventional approach.

Another advantage of the projector system, provided by the present invention, is the ease of color mixing. The use of highly collimated light in the projector system makes the color combiner/mixer easy to design and manufacture.

While the various embodiments of the invention have been illustrated and described, it will be clear that the invention is not limited to these embodiments only. Numerous modifications, changes, variations, substitutions and equivalents will be apparent to one skilled in the art, without departing from the spirit and scope of the invention, as described in the claims.

What is claimed is:

1. A projector system for projecting an image on a projection screen, the projector system comprising:
an illumination system providing tightly collimated light;
at least one imager modulating the collimated light according to the information required for image formation;
a diffuser diffusing the modulated collimated light into a divergent light, thereby relaying the image from the at least one imager to the diffuser; and
a projection lens, projecting the divergent light on the projection screen.

2. The projector system as recited in claim 1 wherein a receiving cone of the projection lens is matched to a divergent cone of the diffuser.

3. The projector system as recited in claim 1 wherein the illumination system provides highly collimated light.

4. The projector system as recited in claim 1 wherein the illumination system comprises a light source that is one of the group consisting of tungsten-halogen lamps, Xenon lamps, ultra high pressure lamps, high intensity discharge lamps, light emitting diode and laser.

5. The projector system as recited in claim 1 wherein the illumination system comprises:
a light source emitting non-collimated light; and
a collimator for collimating the non-collimated light emitted by the light source.

6. The projector system as recited in claim 1 wherein the projector system further comprises a plurality of light redirectors

7. The projector system as recited in claim 6 wherein each light redirector is any one of the group consisting of a total internal reflection prism, a polarization beam splitter, color mixer, and a plurality of mirrors.

8. The projector system as recited in claim 1 wherein the projector system further comprises an adjusting mechanism to adjust the distribution of the diffused light and the position of the diffuser between the at least one imager and the projection lens.

9. The projector system as recited in claim 1 wherein each imager of the at least one imager corresponds to one primary color of the image.

10. The projector system as recited in claim 9 wherein the projector system further comprises a color-mixing device to mix the collimated light received from each imager of the at least one imager.

11. The projector system as recited in claim 1 wherein the at least one imager is based on one of the group of technologies consisting of transmissive LCD, reflective LCOS, and DMD.

12. The projector system as recited in claim 1 wherein the diffuser is any one of the group consisting of a holographic diffuser, plastic film diffuser, and a ground glass diffuser.

13. The projector system as recited in claim 1 wherein the projection lens has short back focal length.

14. The projector system as recited in claim 1 wherein a single imager provides full color projection using the color sequential technique.

15. The projection system as recited in claim 1 wherein the image is one of a full-color image, a monochromatic image, and a grayscale image.

16. The projector system as recited in claim 1 wherein the projection lens has a receiving cone that is matched to the divergent cone of the diffuser.

17. A projector system for projecting an image on a projection screen, the projector system comprising:
an illumination system providing collimated light;
at least one imager modulating the provided light according to the information required for image formation;
a diffuser diffusing the modulated light into a divergent light, thereby relaying the image from the at least one imager to the diffuser; and
a projection lens projecting the divergent light on the projection screen.
